(19) United States
(12) Patent Application Publication
(10) Pub. No.: US 2018/0283626 A1
(43) Pub. Date: Oct. 4, 2018

(54) LIGHT-EMITTING DEVICE, DISPLAY APPARATUS, AND LIGHTING APPARATUS

(71) Applicant: Sony Corporation, Tokyo (JP)

(72) Inventors: Masayasu Watanabe, Tokyo (JP); Hiroki Asakawa, Aichi (JP); Kenji Kobayashi, Kanagawa (JP); Kenichi Nakaki, Tokyo (JP); Nobuki Oshima, Tokyo (JP)

(73) Assignee: Sony Corporation, Tokyo (JP)

(21) Appl. No.: 15/765,814

(22) PCT Filed: Aug. 18, 2016
(86) PCT No.: PCT/JP2016/074107

§ 371 Date: Apr. 4, 2018

(30) Foreign Application Priority Data
Oct. 14, 2015 (JP) 2015-202983
Oct. 26, 2015 (JP) 2015-209821

(51) Int. Cl. F21S 2/00; G02F 1/1335; H05B 37/02; F21V 23/06

(52) U.S. Cl. CPC F21S 2/005; G02F 1/133608; F21Y 2115/10; F21V 23/06; H05B 37/02

(57) ABSTRACT

A light-emitting device is provided that has a light-emitting performance of higher grade, while achieving thickness reduction and an increased light-emitting area. The light-emitting device includes a base on which one or more light sources are provided, the base including a front surface and a rear surface; an optical sheet including an inner surface that faces the front surface of the base and an outer surface on side opposite to the base; one or more columnar members that stand on the base toward the optical sheet, the columnar members each including a top part that abuts on the inner surface of the optical sheet or is provided abuttable on the inner surface of the optical sheet; and one or more anchoring members that each couple the base and the optical sheet, the anchoring members each exhibiting elasticity in at least a portion thereof.

### TECHNICAL FIELD

The disclosure relates to a light-emitting device, and to a display apparatus and a lighting apparatus that include such a light-emitting device.

### BACKGROUND ART

There has been known a surface-emitting device as a direct backlight to be mounted on a liquid crystal display apparatus. On the surface-emitting device is provided a diffusion plate which is so provided as to cover a plurality of light sources. For example, reference is made to PTL 1 to PTL 3.

### CITATION LIST

### Patent Literature

PTL 1: Japanese Unexamined Patent Application Publication No. 2006-208466
PTL 2: International Publication No. WO 2010/052955
PTL3: Japanese Unexamined Patent Application Publication No. 2010-192299

### SUMMARY OF THE INVENTION

Recently, however, there has been a demand for a light-emitting device that is able to achieve further thickness reduction and an increased light-emitting area without inhibiting a light-emitting performance such as luminance distribution.

It is therefore desirable to provide a light-emitting device having a light-emitting performance of higher grade, while achieving thickness reduction and an increased light-emitting area, and a display apparatus and a lighting apparatus each including the light-emitting device.

A light-emitting device according to an embodiment of the disclosure includes a base on which one or more light sources are provided, the base including a front surface and a rear surface; an optical sheet including an inner surface that faces the front surface of the base and an outer surface on side opposite to the base; one or more columnar members that stand between the base and the optical sheet, the columnar members each including a top part that abuts on the inner surface of the optical sheet or is provided abuttable on the inner surface of the optical sheet; and one or more anchoring members that each couple the base and the optical sheet, the anchoring members each exhibiting elasticity in at least a portion thereof. In addition, a display apparatus and a lighting apparatus according to respective embodiments of the disclosure each include the light-emitting device.

According to the light-emitting device, the display apparatus, and the lighting apparatus of the respective embodiments of the disclosure, the columnar members are provided between the base and the optical sheet that are disposed to face each other, which thus prevents the optical sheet from being displaced (or bending) in a direction approaching the base. In addition, the base and the optical sheet are coupled by the anchoring members, which thus prevents the optical sheet from being displaced (or bending) in a direction moving away from the base. Here, the anchoring member exhibits elasticity in at least a portion of itself, and thus the anchoring member extends or contracts in accordance with an amount of displacement (or an amount of bending) of the optical sheet, allowing a dimension in a longitudinal direction to change. Therefore, the anchoring member has excellent follow-up capability to the displacement (or the bending) of the optical sheet, thus preventing excessive load from being exerted on the anchoring member itself and on the optical sheet. Accordingly, it becomes easier to stably maintain an appropriate spacing over time between the light source provided on the base and the optical sheet facing that light source.

According to the light-emitting device according to the embodiment of the disclosure, the spacing between the light source and the optical sheet is maintained appropriately. Thus, it is possible for the light-emitting device to achieve surface light emission of higher grade, while attempting to reduce the thickness and increase the area of the light-emitting device itself. This enables the display apparatus using this light-emitting device to perform excellent visual expressions. In addition, the lighting apparatus using this light-emitting device enables provision of high-grade lighting, such as provision of more uniform lighting, for example, to a target. It is to be noted that the effects of the disclosure are not limited to those described above, and may be any of effects that are described in the following.

### BRIEF DESCRIPTION OF DRAWINGS

FIG. 1 is a schematic cross-sectional view of an overall configuration example of a light-emitting device according to a first embodiment in the disclosure.

FIG. 2A is an enlarged cross-sectional view of a first configuration example of a main part of the light-emitting device illustrated in FIG. 1.

FIG. 2B is an enlarged cross-sectional view of a second configuration example of the main part of the light-emitting device illustrated in FIG. 1.

FIG. 2C is an enlarged cross-sectional view of a third configuration example of the main part of the light-emitting device illustrated in FIG. 1.

FIG. 2D is an enlarged cross-sectional view of a fourth configuration example of the main part of the light-emitting device illustrated in FIG. 1.

FIG. 3A is an enlarged cross-sectional view of a configuration of a main part of a light-emitting device according to a first modification example of the disclosure.

FIG. 3B is an enlarged cross-sectional view of a configuration of a main part of a light-emitting device according to a second modification example of the disclosure.

FIG. 3C is an enlarged cross-sectional view of a configuration of a main part of a light-emitting device according to a third modification example of the disclosure.

FIG. 4 is a schematic view of an overall configuration example of a light-emitting device according to a second embodiment in the disclosure.

FIG. 5 is a schematic view of a light-emitting device according to a fourth modification example of the disclosure.

FIG. 6 is a perspective view of an external appearance of a display apparatus according to a third embodiment of the disclosure.

FIG. 7A is an exploded perspective view of a main body part illustrated in FIG. 6.

FIG. 7B is an exploded perspective view of a panel module illustrated in FIG. 7A.

FIG. 8A is a perspective view of an external appearance of a tablet terminal apparatus mounted with the display apparatus according to the disclosure.

FIG. 8B is a perspective view of an external appearance of another tablet terminal apparatus mounted with the display apparatus according to the disclosure.

FIG. 9 is a perspective view of an external appearance of a first lighting apparatus that includes the light-emitting device of the disclosure.

FIG. 10 is a perspective view of an external appearance of a second lighting apparatus that includes the light-emitting device of the disclosure.

FIG. 11 is a perspective view of an external appearance of a third lighting apparatus that includes the light-emitting device of the disclosure.

FIG. 12 is a schematic view of a main part of a light-emitting device according to a fifth modification example of the disclosure.

FIG. 13 is a schematic view of a main part of a light-emitting device according to a sixth modification example of the disclosure.

### MODES FOR CARRYING OUT THE INVENTION

In the following, some embodiments of the disclosure are described in detail with reference to the drawings. It is to be noted that the description is given in the following order.

### 1. First Embodiment

A light-emitting device in which an end of an anchoring member is attached, via an elastic member, to a bracket fixed to a rear surface of a housing.

### 2. First Modification Example of First Embodiment (First Modification Example)

A light-emitting device in which the end of the anchoring member is attached to the rear surface of the housing via the elastic member (a coil spring) without using the bracket.

### 3. Second Modification Example of First Embodiment (Second Modification Example)

A light-emitting device in which the end of the anchoring member is attached to the rear surface of the housing via the elastic member (a leaf spring) without using the bracket.

### 4. Third Modification Example of First Embodiment (Third Modification Example)

A light-emitting device that has an elastic part provided in a portion of the anchoring member.

### 5. Second Embodiment

A light-emitting device that adjusts tension in the anchoring member using a servomotor and a tension detector in place of the elastic member.

### 6. Modification Example of Second Embodiment (Fourth Modification Example)

A light-emitting device that predicts an amount of heat generation of a light source to adjust the tension in the anchoring member.

7. Third Embodiment (Display apparatus; Liquid Crystal Display Apparatus)

### 8. Application Example of Display Apparatus

### 9. Application Example of Lighting Apparatus

### 10. Other Modification Examples

### 1. First Embodiment

### [Configuration of Light-Emitting Device 10]

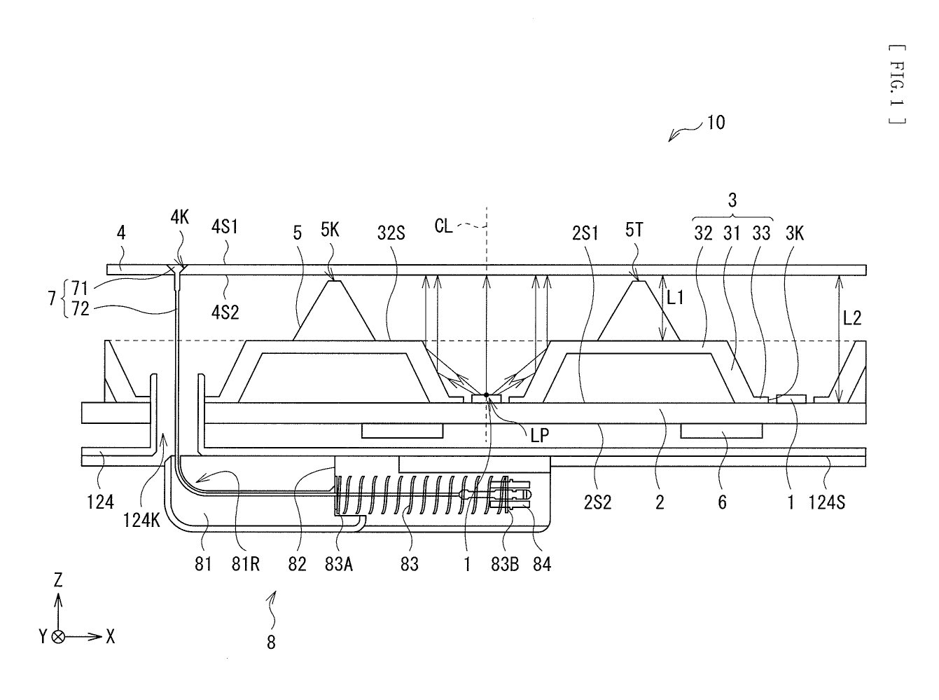

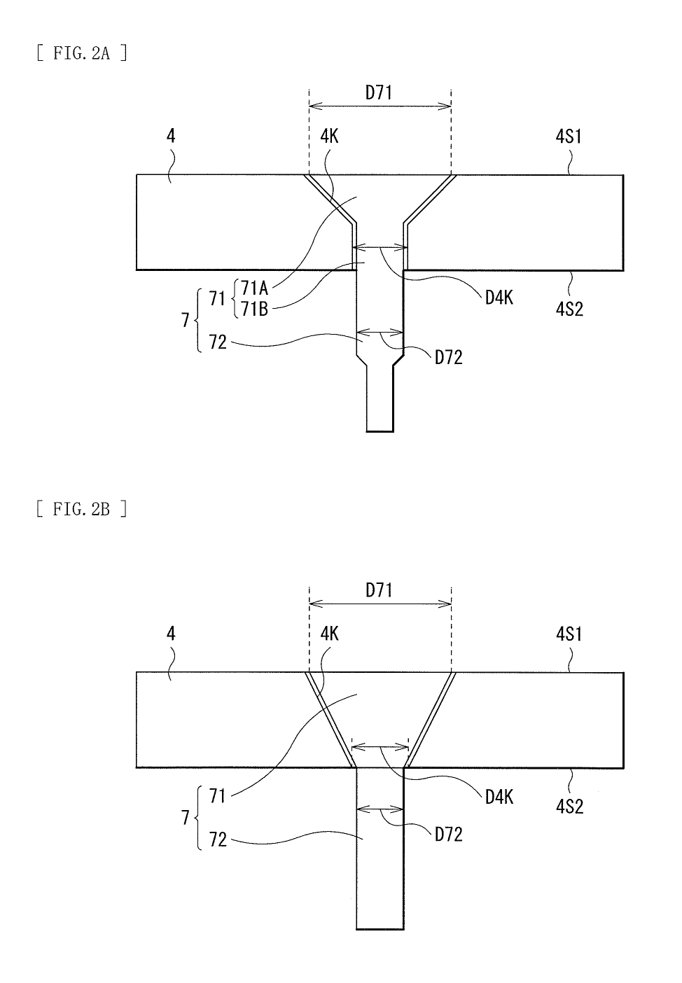

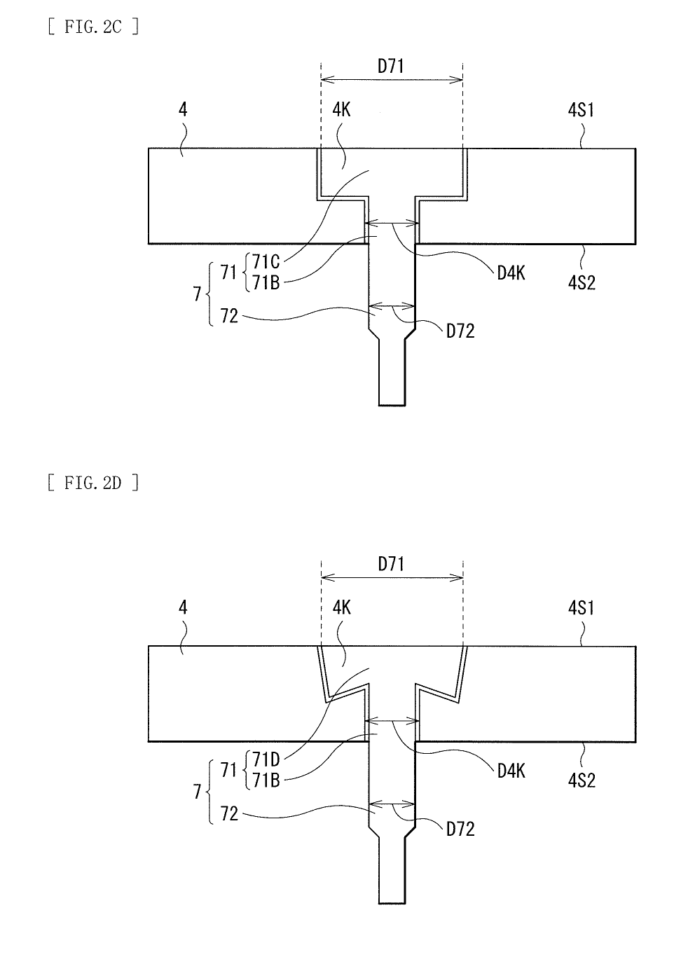

FIG. 1 is a schematic cross-sectional view of an overall configuration example of a light-emitting device 10 according to the first embodiment of the disclosure. FIG. 2 is an enlarged cross-sectional view of a configuration of a main part of the light-emitting device 10 illustrated in FIG. 1.

The light-emitting device 10 includes a light source substrate 2 on which a plurality of light sources 1 are provided, and a reflective plate 3 placed on a front surface 2S1 of the light source substrate 2, for example. It is to be noted that the light sources 1, the light source substrate 2, and the reflective plate 3 are contained in a back housing 124, which is a back chassis. Here, a combination of the light source substrate 2 and the back housing 124 is a specific example corresponding to a “base” of the disclosure. The light-emitting device 10 further includes an optical sheet 4, a stud 5, and a drive circuit 6, etc., for example. The drive circuit 6 drives each of the light sources 1, for example, and is provided on a rear surface 2S2 of the light source substrate 2, for example.

In the specification, a direction of a distance linking the light source substrate 2 and the optical sheet 4 is a Z direction, which is a front-back direction. A right-left direction and a top-bottom direction on principal faces, i.e., the largest faces of the light source substrate 2 and the optical sheet 4 are an X direction and a Y direction, respectively.

The plurality of light sources 1 are each placed on the front surface 2S1 of the light source substrate 2, for example, and are disposed in matrix, for example. The light source 1 is a point light source, for example, and includes specifically a light emitting diode that oscillates white light. The plurality of light sources 1 are disposed, one by one, at positions corresponding to a plurality of openings 3K formed on the reflective plate 3, for example.

The reflective plate 3 has a function of exerting an optical action on incident light. Examples of the optical action may include reflection, dispersion, and scattering. The reflective plate 3 includes a bottom surface part 33, an inclined part 31, and a top surface part 32, for example. On the bottom surface part 33 are formed the openings 3K into which the respective light sources 1 are inserted. The inclined part 31 includes an inclined surface 31S. The inclined surface 31S encompasses the opening 3K, and is inclined with respect to the light source substrate 2. The top surface part 32 is coupled to an upper end of the inclined part 31. The top surface part 32 is spaced apart from the light source substrate 2, and extends along the front surface 2S1, for example. The light source 1 includes a light-emitting point LP on an upper end along an optical axis CL.

The reflective plate 3 may be a reflective plate in which the bottom surface part 33, the inclined part 31, and the top surface part 32 are integrally molded, for example, by being curved out from a plate-like member, or by means of injection molding or hot press molding, etc. Examples of constituent materials of the reflective plate 3 include polycarbonate resins, acrylic resins such as a polymethyl methacrylate resin (PMMA), polyester resins such as polyethylene terephthalate, amorphous copolymer polyester resins such as MS (copolymers of methyl methacrylate and styrene), polystyrene resins, and polyvinyl chloride resins.

The reflective plate 3 is provided in this light-emitting device 10, whereby light emitted from the light source 1 is reflected at the surface 31S of the inclined part 31, and travels toward the optical sheet 4. Alternatively, after having been emitted from the light source 1 and having reached the optical sheet 4, the light returns from the optical sheet 4, and is reflected, dispersed, or scattered at the inclined part 31, the top surface part 32, or the bottom surface part 33 to travel toward the optical sheet 4. Such an action enables the light-emitting device 10 mounted with the reflective plate 3 to collect light into a region desired to be lighted, while efficiently utilizing the light from the light source 1 to improve frontal luminance. Thus, it is possible to achieve enhancement in area contrast performance. In addition, planarization of the luminance distribution in an X-Y plane is achieved to prevent a boundary with light coming from other adjacent light sources 1 from appearing clearly.

As illustrated in FIG. 1, for example, the optical sheet 4 is placed over a top part 5T of each of the plurality of studs 5 that stands on top surfaces 32S of respective top surface parts 32 of the reflective plate 3. It is to be noted that the studs 5 may be provided directly on the front surface 2S1 of the light source substrate 2. The top part 5T abuts on an inner surface 4S2 of the optical sheet 4, or is provided abuttable on the inner surface 4S2 of the optical sheet 4. The optical sheet 4 is disposed to face the light source 1 and the reflective plate 3 to cover the plurality of light source 1 in common. The plurality of studs 5 keep the top surfaces 32S and the inner surface 4S2 of the optical sheet 4 at a constant spacing L1. Therefore, a spacing L2 between the front surface 2S1 of the light source substrate 2 and the inner surface 4S2 of the optical sheet 4 is also kept constant.

The optical sheet 4 is a laminate in which, for example, a plurality of sheet-like members such as a diffusion plate, a diffusion sheet, a lens film, and a polarization separation sheet are stacked. Alternatively, the optical sheet 4 may be made of only any one of the sheet-like members mentioned above. FIG. 1 describes the plurality of these sheet-like members collectively as one laminated structure. Provision of such an optical sheet 4 makes it possible to raise the light emitted obliquely from the light source 1 or light emitted obliquely from the reflective plate 3 to a front direction. This enables further improvement of the frontal luminance. Light that enters the inner surface 4S2 of the optical sheet 4 from the light source 1 is finally outputted from an outer surface 4S1 of the optical sheet 4. In addition, one or more through-holes 4K are provided in the optical sheet 4.

The light-emitting device 10 further includes the anchoring member 7 that couples the back housing 124 and the optical sheet 4. The anchoring member 7 exhibits elasticity in at least a portion thereof. The anchoring member 7 includes an engaging part 71 which engages with the through-hole 4K and a drawing part 72 having one end that is coupled to the engaging part 71.

As illustrated in FIG. 2A, for example, the engaging part 71 includes a tapered part 71A and a columnar part 71B. The tapered part 71A has an outer diameter that gradually decreases from the outer surface 4S1 to the inner surface 4S2 of the optical sheet 4. The columnar part 71B has a constant outer diameter. The columnar part 71B is located between the tapered part 71A and the drawing part 72, and is coupled to both of the tapered part 71A and the drawing part 72. A maximum outer diameter D71 of the engaging part 71 is larger than a minimum inner diameter D4K of the through-hole 4K. Thus, even when the drawing part 72 pulls the engaging part 71 to side of the light source substrate 2, the engaging part 71 does not pass through the through-hole 4K. It is to be noted that a shape of the engaging part 71 is not limited to the shape illustrated in FIG. 2A, and may be modified in various ways. As illustrated in FIG. 2B, for example, the entire engaging part 71 may have a tapered shape. In addition, as illustrated in FIG. 2C, for example, the engaging part 71 may have a T-shaped cross-section where a flat plate part 71C is attached to an end of the columnar part 71B. Alternatively, as illustrated in FIG. 2D, the engaging part 71 may have a cross-section including an acutely angled part 71D.

Meanwhile, a maximum outer diameter of the drawing part 72 is smaller than the minimum inner diameter D4K of the through-hole 4K, thus enabling the drawing part 72 to pass through the through-hole 4K. Therefore, when the light-emitting device 10 is manufactured or repaired, it is possible to attach the anchoring member 7 to the optical sheet 4 by inserting the anchoring member 7 from the outer surface 4S1 to the inner surface 4S2 of the optical sheet 4. In addition, the drawing part 72 may include a material having flexibility.

In the light source substrate 2 and the back housing 124, a through-hole 124K is provided at a position corresponding to the through-hole 4K. The drawing part 72 is inserted into the through-hole 124K, and includes the other end that is elastically attached to a bracket 8 fixed to a rear surface 124S of the back housing 124. Here, the other end of the drawing part 72 is attached to the bracket 8 via an elastic member 83 such as a coil spring. In the bracket 8 are provided a pass line 81 and a locking part 82. The pass line 81 includes a curved part 81R. The locking part 82 abuts on a front end 83A of the elastic member 83 to lock the elastic member 83. The other end of the drawing part 72 is fixed to a back end 83B of the elastic member 83 by means of a fixture 84, for example.

### [Workings and Effects of Light-Emitting Device 10]

The light source 1 is the point light source. Thus, the light emitted from the light source 1 spreads from the light-emitting point LP of the light source 1 at 360° in all directions, finally passes through the optical sheet 4, and is observed as emission of light on the outside of the optical sheet 4 (i.e., on side opposite to the optical source 1). Here, the light source 1 generates heat upon emitting light, and thus there may be a case where the optical sheet 4 expands when heat is transferred to the optical sheet 4. In addition, even if lighting is off, there may be a case where the optical sheet 4 bends due to its own weight when the light-emitting device 10 is placed to allow a light-emitting surface (i.e., a principal surface) of the light-emitting device 10 to be along a vertical direction.

Therefore, in the light-emitting device 10 of the embodiment, the stud 5 is provided between the light source substrate 2 (or the back housing 124) and the optical sheet 4 that are disposed opposite to each other. This makes it possible to prevent the optical sheet 4 from being displaced (or bending), in a direction in which the optical sheet 4 approaches the light source substrate 2 (or the back housing 124). Further, the back housing 124 and the optical sheet 4 are coupled by the anchoring member 7. This makes it possible to prevent the optical sheet 4 from being displaced (or bending) in a direction in which the optical sheet 4 moves away from the light source substrate 2 (or the back housing 124). Here, the anchoring member 7 exhibits elasticity in at least a portion of itself, and thus the anchoring member 7 extends or contracts in accordance with an amount of displacement (or an amount of bending) of the optical sheet 4, and a dimension thereof in a longitudinal direction changes. Accordingly, the anchoring member 7 enables stabilization of tension positively and dynamically acting on the anchoring member 7 itself against the displacement (or the bending) of the optical sheet. This avoids excessive load (or the tension) on the anchoring member 7 itself and the optical sheet 4. Therefore, it is possible to avoid a damage to the anchoring member 7 or the optical sheet 4, for example, when the light-emitting device 10 is assembled, when the light-emitting device 10 after being completed is transported, or even when vibration attributable to various factors such as an earthquake is applied to the light-emitting device 10 after having being installed. In addition, by providing the anchoring member 7 having excellent follow-up capability to the displacement (or the bending) of such an optical sheet, it becomes easier to stably maintain an appropriate spacing over time between the light source 1 provided on the light source substrate 2 and the optical sheet 4 facing the light source 1. Note that it is more preferable that the entire drawing part 72 includes an elastic material, because the follow-up capability of the anchoring member 7 is thereby enhanced.

For the reasons as described above, in the light-emitting device 10 of the embodiment, it is possible to achieve surface light emission of higher grade while attempting to reduce the thickness and increase the area of the light-emitting device 10 itself. Accordingly, it is expectable that use of this light-emitting device 10 for the display apparatus, for example, achieves excellent visual expressions. It is also expectable that the use of this light-emitting device 10 for the lighting apparatus achieves high-grade lighting, such as provision of more uniform lighting, for example, to a target.

In addition, in the embodiment, a portion of the anchoring member 7 (specifically, an area around a center of the drawing part 72) is made to be bent along the curved part 81R of the bracket 8, thus allowing for reduction in a thickness (i.e., a dimension in a Z-axis direction) of the light-emitting device 10.

### 2. First Modification Example of First Embodiment

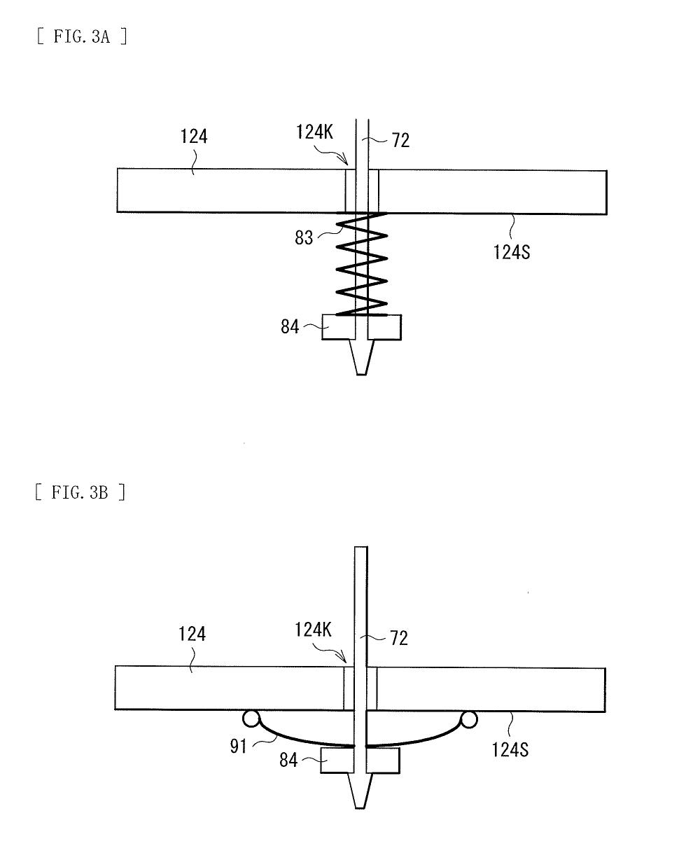

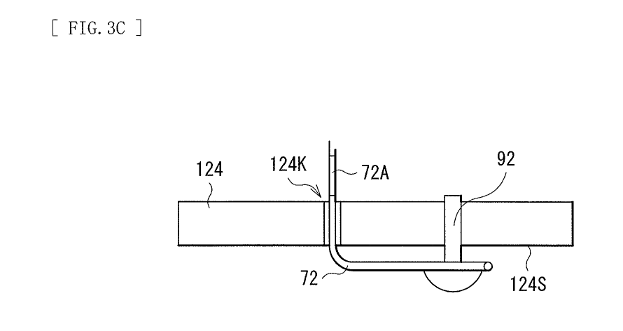

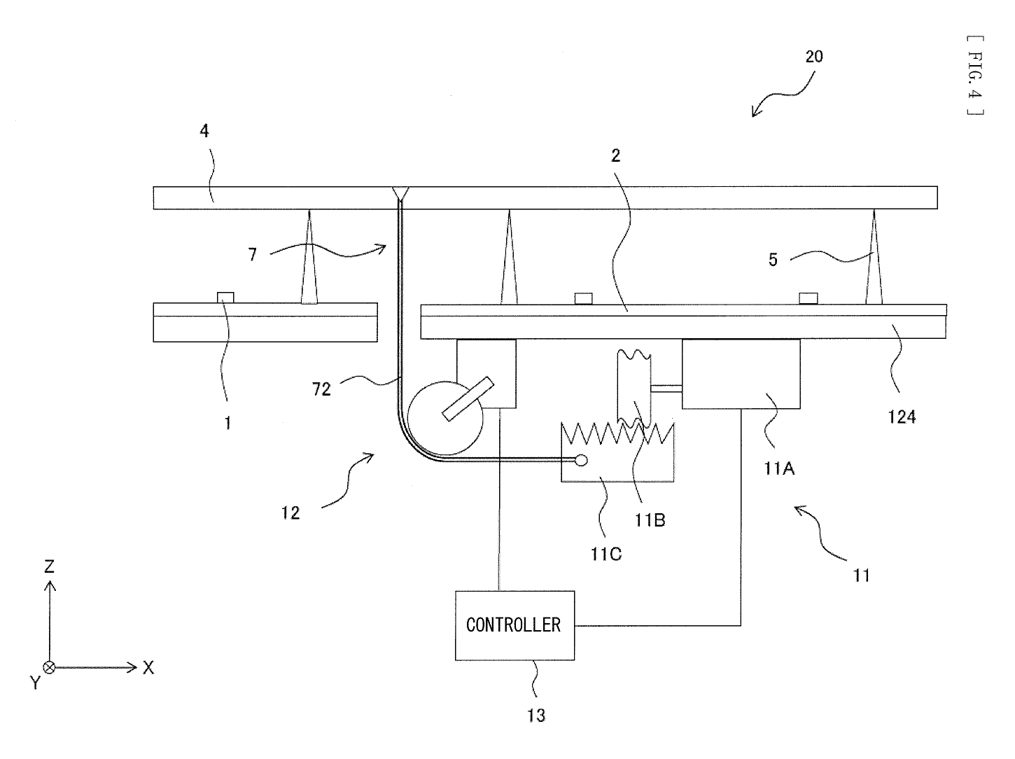

In the foregoing embodiment, the bracket 8 is fixed to the rear surface of the back housing 124,s and the other end of the drawing part 72 is elastically attached to that bracket 8. The disclosure, however, is not limited thereto. As with the first modification example illustrated in FIG. 3A, for example, the elastic member 83 may be locked by causing the elastic member 83 to directly abut on an outer edge of the rear surface 124S of the through-hole 124K in the back housing 124, without using the bracket 8. It is also possible, in the modification example, to not only reduce the number of components, but also obtain the workings and effects, similarly to the foregoing embodiment.

### 3. Second Modification Example of First Embodiment

In the foregoing embodiment, the coil spring is used as the elastic member 83 when the other end of the drawing part 72 is attached to the bracket 8. The disclosure, however, is not limited thereto. As with the second modification example illustrated in FIG. 3B, for example, a leaf spring 91 may also be used to elastically attach the other end of the drawing part 72 to the back housing 124. This case is more suited for the thickness reduction than the first modification example described above.

### 4. Third Modification Example of First Embodiment

In the embodiment as well as the first modification example and the second modification example described above, the other end of the drawing part 72 is elastically attached to the back housing 124 via the elastic member such as the coil spring or the leaf spring. The disclosure, however, is not limited thereto. As with the third modification example illustrated in FIG. 3C, for example, by forming an elastic part 72A on a portion of the drawing part 72 in the longitudinal direction, the drawing part 72 may be stretchably configured in the longitudinal direction. In that case, the other end of the drawing part 72 may be fixed to the back housing 124 by means of a screw 92, for example. This case is even more suited for the thickness reduction than the second modification example described above.

### 5. Second Embodiment

### [Configuration of Light-Emitting Device 20]

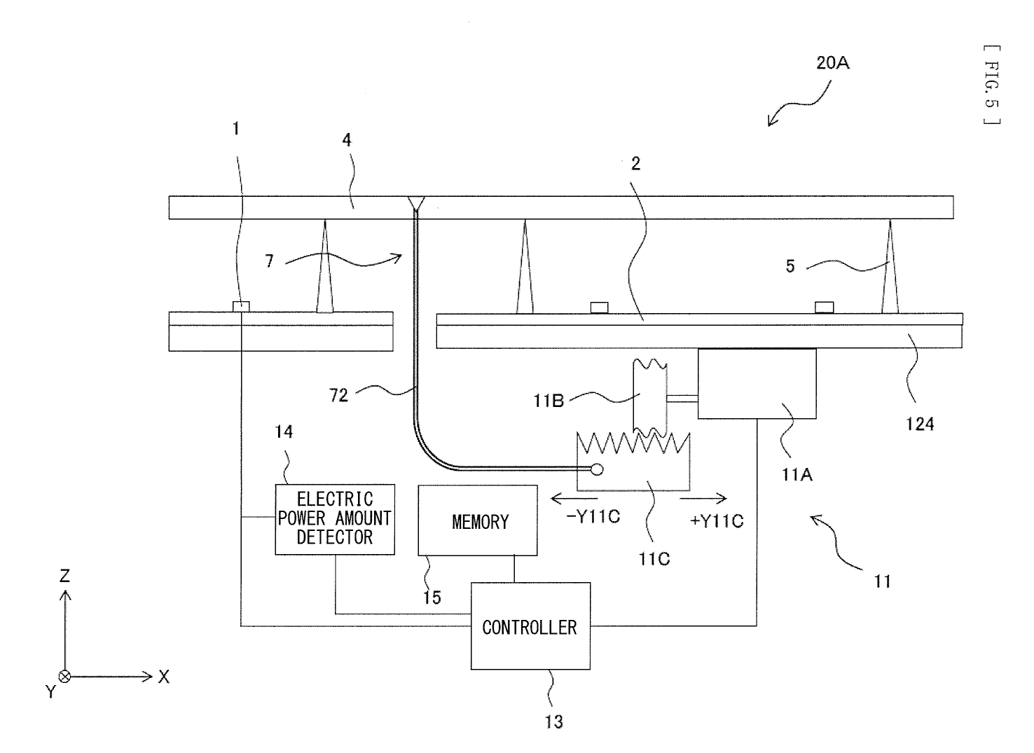

FIG. 4 is a schematic cross-sectional view of an overall configuration example of the light-emitting device 20 according to the second embodiment of the disclosure. The light-emitting device 20 of the embodiment includes a driver 11 in place of the bracket 8, and further includes a tension detector 12 and a controller 13. Except these points, the light-emitting device 20 has a configuration that is substantially similar to that of the light-emitting device 10 of the foregoing first embodiment. Therefore, the same reference numerals are assigned to constitutional elements that are substantially the same as those of the light-emitting device 10, and description thereof is omitted where appropriate.

The driver 11 is a mechanism that increases and decreases tension in the anchoring member 7. The driver 11 includes a servomotor 11A, a pinion gear 11B, and a rack 11C, for example. The pinion gear 11B rotates as the servomotor 11A rotates. The rack 11C includes a gear that mates with the pinion gear 11B. When the pinion gear 11B rotates due to driving of the servomotor 11A, the rack 11C travels straight along the rear surface of the back housing 124 in a direction of an arrow +Y11C or an arrow −Y11C. To the rack 11C is coupled the other end of the drawing part 72 of the anchoring member 7. Therefore, the drawing part 72 is strained or relaxed in its longitudinal direction due to the driving of the servomotor 11A. Specifically, when the rack 11C travels in the direction of the arrow +Y11C, tension to be loaded on the drawing part 72 increases. This intensifies force with which the engaging part 71 and the optical sheet 4 engaged therewith are pulled in a direction approaching the back housing 124. On the contrary, when the rack 11C travels in the direction of the arrow −Y11C, the tension to be loaded on the drawing part 72 decreases. This weakens the force with which the engaging part 71 and the optical sheet 4 engaged therewith are pulled in the direction approaching the back housing 124.

The tension detector 12 is a sensor that detects the tension to be loaded on the drawing part 72 of the anchoring member 7. On the basis of the tension of the drawing part 72 that is detected by this tension detector 12, the controller 13 functions to cause the driver 11 to adjust that tension.

In the light-emitting device 20 of the embodiment, the driver 11 is provided; in addition, the tension detector 12 detects the tension of the drawing part 72, and the controller 13 performs feedback control (i.e., straining and relaxing of the anchoring member 7) of the driver 11. Similarly to the foregoing first embodiment, this makes it possible to avoid excessive load (or tension) on the anchoring member 7 itself and the optical sheet 4, while controlling the displacement (or the bending) of the optical sheet 4. In the embodiment, in particular, the use of the servomotor 11A makes it possible to respond to a wider range of tension and to control the tension with a higher precision.

### 6. Modification Example of Second Embodiment

### [Configuration of Light-Emitting Device 20A]

FIG. 5 illustrates a schematic configuration of a light-emitting device 20A according to a modification example of the foregoing second embodiment. The light-emitting device 20A has a configuration that is substantially similar to that of the light-emitting device 20, except that the light-emitting device 20A includes an electric power amount detector 14 and a memory 15, in place of the tension detector 12.

The electric power amount detector 14 is to detect input energy (here, an electric power amount) to be inputted to the light source 1. The memory 15 stores data indicating a relationship between the input energy (here, the electric power amount) to the light source 1, for example, and the amount of displacement of the optical sheet 4 caused by heat generation involved in lighting of the light source 1. The controller 13 causes the driver 11 to adjust the tension to be loaded on the drawing part 72 of the anchoring member 7, on the basis of the electric power amount detected by the electric power amount detector 14 and the above-mentioned data stored in the memory 15.

In the modification example, an amount of the heat generation of the light source 1 is predicted to adjust the tension in the anchoring member 7 positively and dynamically, thus making it possible to keep the displacement (or the bending) of the optical sheet 4 smaller. It is to be noted that, in the modification example, the tension detector 12 may also be provided, similarly to the light-emitting device 20.

### 7. Third Embodiment

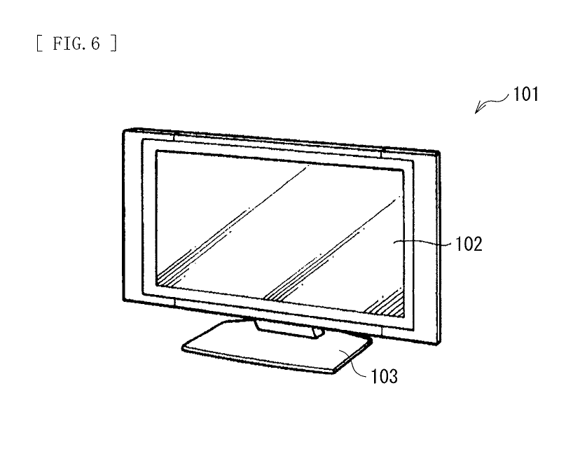

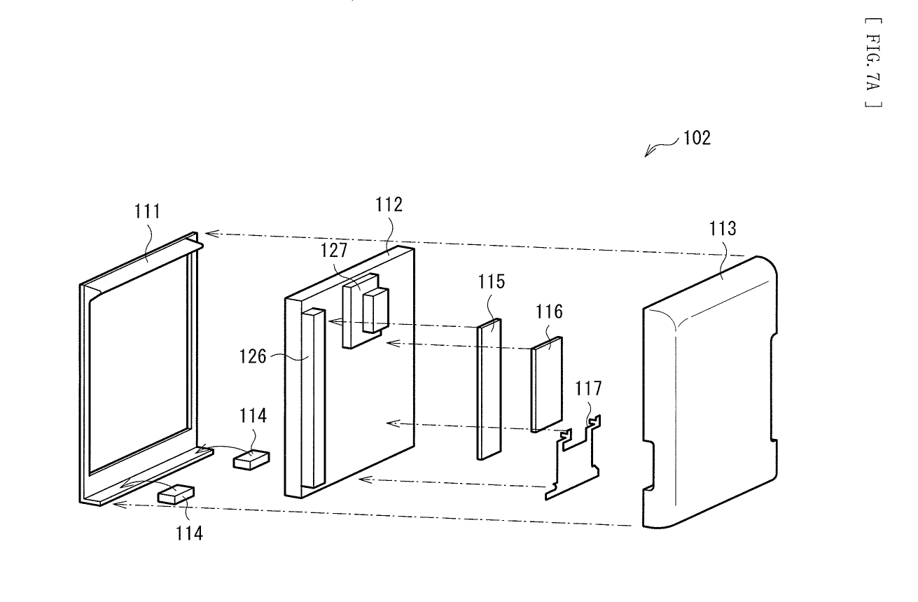

FIG. 6 illustrates an external appearance of a display apparatus 101 according to a third embodiment of the technology. This display apparatus 101 includes the light-emitting device 10, and is used as a flat-screen television. The display apparatus 101 has such a configuration in which a flat plate-shaped main body part 102 for image display is supported by a stand 103. It is to be noted that, although the display apparatus 101 is placed on a horizontal surface such as a floor, a shelf, or a stand to be used as a stationary type, with the stand 103 being attached to the main body part 102, it is also possible to use the display apparatus 101 as a wall-mounted type, with the stand 103 being removed from the main body part 102.

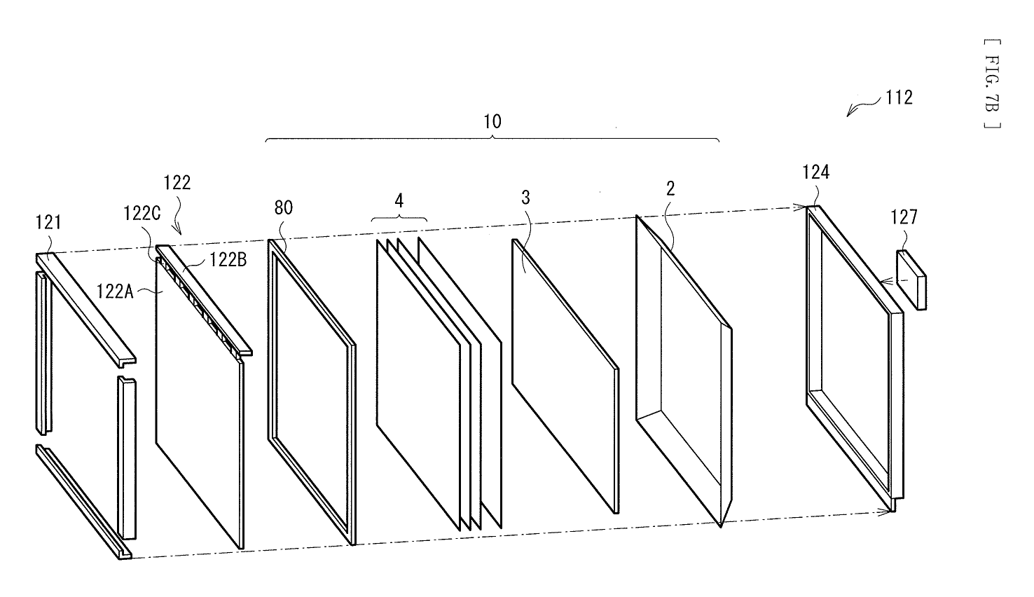

FIG. 7A is an exploded view of the main body part 102 illustrated in FIG. 6. The main body part 102 includes, from a frontal surface side (i.e., a viewer side), for example, a frontal armoring member (i.e., a bezel) 111, a panel module 112, and a rear armoring member 113 (a rear cover) in this order. The frontal armoring member 111 is a frame-shaped member covering a frontal periphery of the panel module 112. The frontal armoring member 111 has a pair of speakers 114 disposed on a lower part. The panel module 112 is fixed to the frontal armoring member 111. On a back surface of the panel module 112 are mounted a power supply substrate 115 and a signal substrate 116, with a metal fitting 117 being fixed. The metal fitting 117 is provided for attachment of a wall-mounted bracket, attachment of the substrate, for example, and attachment of the stand 103. The rear armoring member 113 covers the back surface and side surfaces of the panel module 112.

FIG. 7B is an exploded view of the panel module 112 illustrated in FIG. 7A. The panel module 112 includes, from the frontal surface side (i.e., the viewer side), for example, a front housing (i.e., a top chassis) 121, a liquid crystal panel 122, a frame-shaped member (i.e., a middle chassis) 80, the optical sheet 4, the reflective plate 3, the substrate 2, the back housing (i.e., the back chassis) 124, and a timing controller substrate 127 in this order.

The front housing 121 is a frame-shaped metal component covering the frontal periphery of the liquid crystal panel 122. The liquid crystal panel 122 includes, for example, a liquid crystal cell 122A, a source substrate 122B, and a flexible substrate 122C such as a Chip On Film (COF) which couples these. A frame-shaped member 123 is a frame-shaped resin component holding the liquid crystal panel 122 and an optical sheet 50. The back housing 124 is a metal component that includes iron (Fe), for example. The back housing 124 contains the liquid crystal panel 122, a middle housing 123, and the light-emitting device 10. The timing controller substrate 127 is also mounted on the back surface of the back housing 124.

In this display apparatus 101, light from the light-emitting device 10 is selectively transmitted by the liquid crystal panel 122 to thereby perform image display. Here, as described in the first embodiment, the light-emitting device 10 with improved uniformity of the in-plane luminance distribution is provided, thus allowing for improvement in display quality of the display apparatus 101.

It is to be noted that, in the above-described embodiment, description has been given of a case in which the display apparatus 101 includes the light-emitting device 10 according to the first embodiment; however, the display apparatus 101 may include the light-emitting device 20 according to the second embodiment, in place of the light-emitting device 10.

### 8. Application Example of Display Apparatus

In the following, an application example of the display apparatus 101 as described above to electronic apparatuses is described. Examples of the electronic apparatuses may include a television, a digital camera, a notebook personal computer, a mobile terminal apparatus such as a mobile phone, and a video camera. In other words, the above-described display apparatus is applicable to electronic apparatuses in every field that display externally inputted image signals or internally generated image signals as images or pictures.

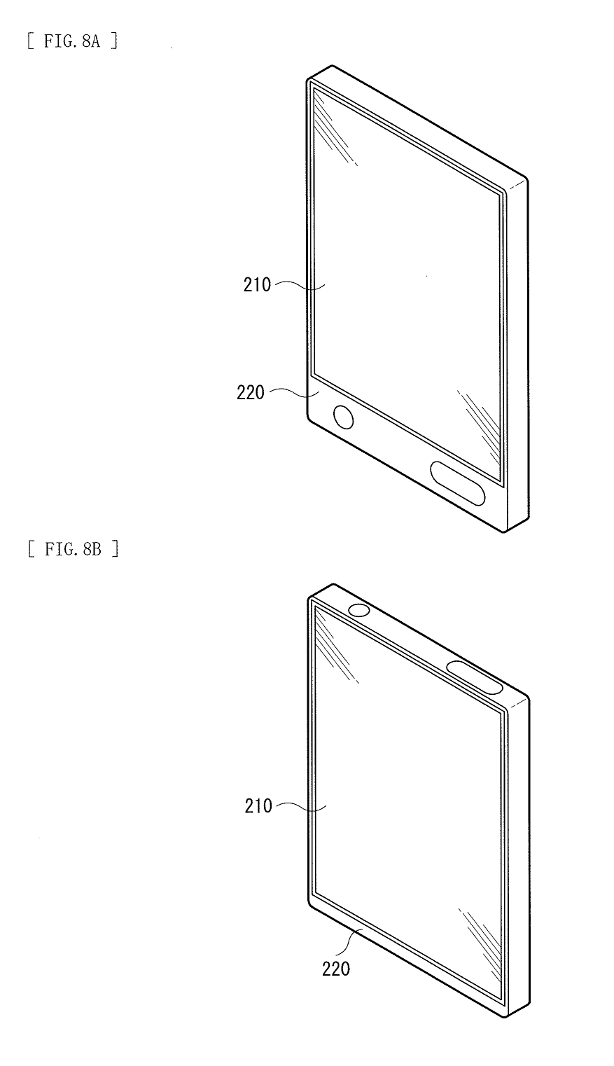

FIG. 8A illustrates an external appearance of a tablet terminal apparatus to which the display apparatus 101 of the foregoing embodiment is applicable. FIG. 8B illustrates an external appearance of another tablet terminal apparatus to which the display apparatus 101 of the foregoing embodiment is applicable. Each of these tablet terminal apparatuses includes, for example, a display section 210 and a non-display section 220, and the display section 210 is configured by the display apparatus 101 of the foregoing embodiment.

### 9. Application Examples of Lighting Apparatus

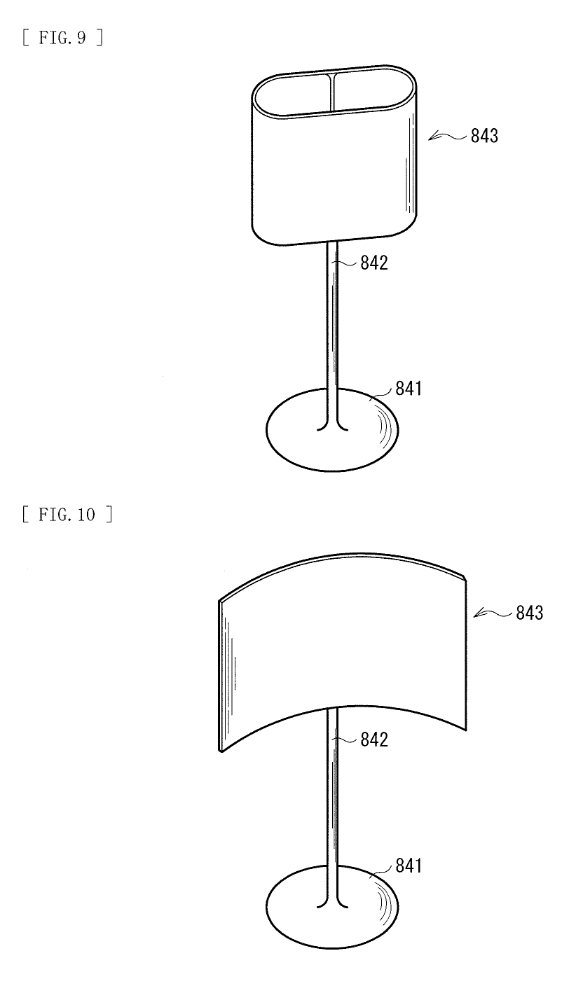

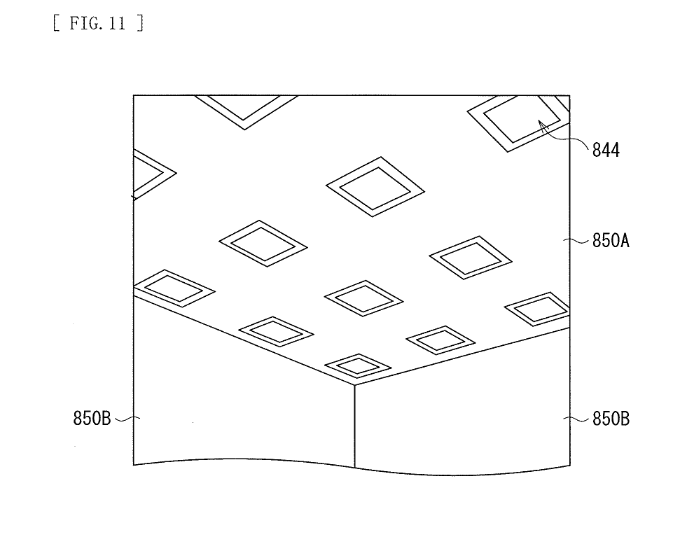

Each of FIGS. 9 and 10 illustrates an external appearance of a tabletop lighting apparatus to which any of the light-emitting devices 10 and 20 of the foregoing embodiments is applicable. The lighting apparatus includes, for example, an illuminating section 843 attached to a support post 842 that is provided on a base 841. The illuminating section 843 is configured by any of the light-emitting devices 10 and 20 according, respectively, to the foregoing first and second embodiments. It is possible for the illuminating section 843 to take any shape such as a tubular shape illustrated in FIG. 9 and a curved surface shape illustrated in FIG. 10, by configuring components such as the substrate 2, the reflective plate 3, and an optical sheet 4 in curved shapes.

FIG. 11 illustrates an external appearance of an indoor lighting apparatus to which any of the light-emitting devices 10 and 20 of the foregoing embodiments is applicable. The lighting apparatus includes an illuminating section 844 that is configured by any of the light-emitting devices 10 and 20, etc. according to the foregoing embodiments, for example. The appropriate number of the illuminating sections 844 are disposed at appropriate spacing intervals on a ceiling 850A of a building. It is to be noted that the illuminating section 844 may be installed not only on the ceiling 850A, but also on any location such as a wall 850B or a floor (not illustrated in the diagram) depending on the intended use.

In these lighting apparatuses, illumination is performed through the light from the respective light-emitting devices 10 and 20. Here, the lighting apparatuses include the respective light-emitting devices 10 and 20, thus making it possible to expect high lighting quality, such as having high uniformity of the in-plane luminance distribution, for example.

The disclosure has been described heretofore with reference to some embodiments and modification examples; however, the disclosure is not limited to the foregoing embodiments, for example, and may be modified in a variety of ways. For example, a material and a thickness, etc. of each of members described in the foregoing embodiments, for example, are not limitative, and any other material and any other thickness may also be adopted. In addition, a shape or a structure of the anchoring member is not limited to those of the foregoing embodiments, for example.

Further, for example, in the foregoing embodiments, the description has been given on the case where the light source 1 is an LED; however, the light source 1 may be configured by a semiconductor laser and so forth.

Additionally, for example, in the foregoing embodiments, for example, the description has been given by citing, as a specific example, configurations of the light-emitting devices 10 and 20 and the display apparatus 101 (the television); however, it is unnecessary to provide all of the components, and other components may be provided.

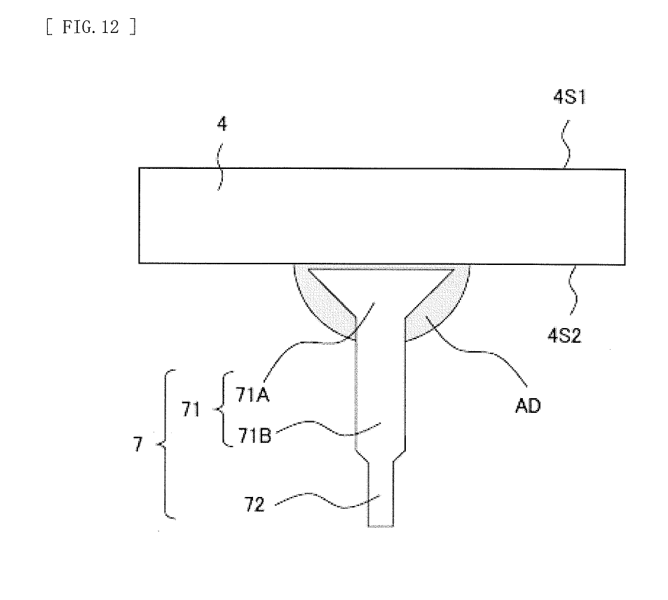

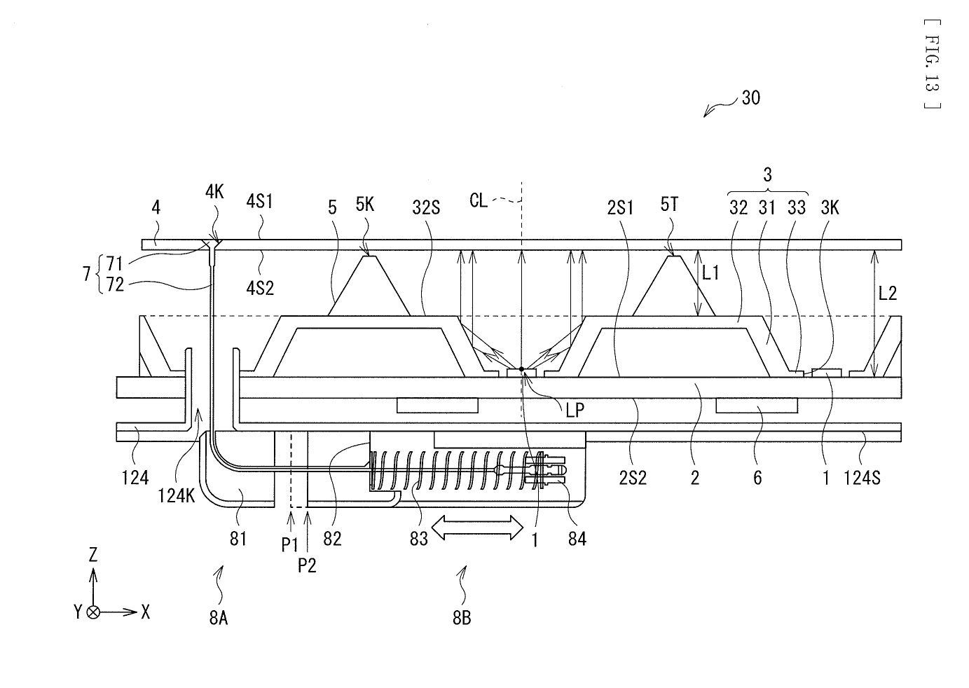

In addition, in the foregoing embodiments, for example, the optical sheet 4 is drawn to approach the light source substrate 2 through provision of the through-hole 4K in the optical sheet 4 and engagement of a portion (the engaging part 71) of the anchoring member 7 with the through-hole 4K. The disclosure, however, is not limited thereto. For example, as with the light-emitting device according to a fifth modification example as illustrated in FIG. 12, the engaging part 71 may be joined to the inner surface 4S2 of the optical sheet 4 via an adhesive AD, for example.

In addition, in the foregoing first embodiment, the bracket 8 is fixed to the rear surface 124S of the back housing 124 to attach the other end of the drawing part 72 to a certain position. However, as with a light-emitting device 30 as a sixth modification example illustrated in FIG. 13, for example, a block 8B may be provided as a switching part to switch an attaching position of the other end of the drawing part 72 with respect to the back housing 124. That is, in the modification example, the bracket 8 is divided into two blocks 8A and 8B, whereby a relative position with the block 8A and the block 8B varies. More specifically, the block 8A in which the pass line 81 is formed is fixed to a position corresponding to the through-hole 124K. In contrast, the block 8B including the locking part 82 is configured to be slidable in an X-axis direction along a groove, etc. provided on the rear surface 124S, for example, thus enabling the block 8B to be temporarily fixed at each of two or more different locations. Such a configuration makes it possible to alleviate the load on the drawing part 72 by temporarily fixing the block 8B at a position P1 where the block 8B is brought closer to the block 8A and by keeping the drawing part 72 in a relaxed state, upon transporting or housing, for example. In contrast, upon installation, the block 8B may be temporarily fixed at a position P2 that is spaced apart from the block 8A, thus keeping the drawing part 72 in a moderately strained state.

It is to be noted that the effects described herein are merely illustrative and non-limiting, and may further include other effects. Moreover, the technology may have the following configurations.

(1)

A light-emitting device including:

a base on which one or more light sources are provided, the base including a front surface and a rear surface;

an optical sheet including an inner surface that faces the front surface of the base and an outer surface on side opposite to the base;

one or more columnar members that stand between the base and the optical sheet, the columnar members each including a top part that abuts on the inner surface of the optical sheet or is provided abuttable on the inner surface of the optical sheet; and

one or more anchoring members that each couple the base and the optical sheet, the anchoring members each exhibiting elasticity in at least a portion thereof.

(2)

The light-emitting device according to (1), in which the anchoring member includes an elastic material in at least a portion thereof.

(3)

The light-emitting device according to (1) or (2), in which

the optical sheet has one or more first through-holes from the inner surface to the outer surface, and

the anchoring member includes an engaging part that engages with the first through-hole, and a drawing part having one end to which the engaging part is coupled.

(4)

The light-emitting device according to (3), in which the drawing part has a maximum outer diameter that is smaller than a minimum inner diameter of the first through-hole.

(5)

The light-emitting device according to (3) or (4), in which the drawing part has the other end that is attached to the base via an elastic member.

(6)

The light-emitting device according to any one of (3) to (5), in which

the base further has a second through-hole at a position corresponding to the first through-hole, and

the drawing part is inserted into the second through-hole, and has the other end that is attached to the rear surface of the base.

(7)

The light-emitting device according to any one of (3) to (6), in which the drawing part has flexibility.

(8)

The light-emitting device according to (5), further including a switching part that switches an attaching position of the drawing part to the base.

(9)

The light-emitting device according to (1), further including a driver that increases and decreases tension in the anchoring member.

(10)

The light-emitting device according to (9), further including:

a tension detector that detects tension to be loaded on the anchoring member; and

a controller that causes the driver to adjust the tension on a basis of the tension detected by the tension detector.

(11)

The light-emitting device according to (9) or (10), further including:

an energy detector that detects input energy to be inputted to the light sources;

a memory that stores data indicating a relationship between the input energy and an amount of displacement of the optical sheet, the displacement being caused by heat generation involved in lighting of the light sources; and

a controller that causes the driver to adjust the tension on a basis of the input energy detected by the energy detector and the data.

(12)

A display apparatus including a liquid crystal panel and a light-emitting device according to any one of (1) to (11), the light-emitting device being on side of a back surface of the liquid crystal panel.

(13)

A lighting apparatus including a light-emitting device according to any one of (1) to (11).

This application claims the benefits of Japanese Priority Patent Applications JP2015-202983 filed on Oct. 14, 2015 and JP2015-209821 filed on Oct. 26, 2015, the entire contents of both of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A light-emitting device comprising:
a base on which one or more light sources are provided, the base including a front surface and a rear surface;
an optical sheet including an inner surface that faces the front surface of the base and an outer surface on side opposite to the base;
one or more columnar members that stand between the base and the optical sheet, the columnar members each including a top part that abuts on the inner surface of the optical sheet or is provided abuttable on the inner surface of the optical sheet; and
one or more anchoring members that each couple the base and the optical sheet, the anchoring members each exhibiting elasticity in at least a portion thereof.

2. The light-emitting device according to claim 1, wherein the anchoring member includes an elastic material in at least a portion thereof.

3. The light-emitting device according to claim 1, wherein
the optical sheet has one or more first through-holes from the inner surface to the outer surface, and
the anchoring member includes an engaging part that engages with the first through-hole, and a drawing part having one end to which the engaging part is coupled.

4. The light-emitting device according to claim 3, wherein the drawing part has a maximum outer diameter that is smaller than a minimum inner diameter of the first through-hole.

5. The light-emitting device according to claim 3, wherein the drawing part has the other end that is attached to the base via an elastic member.

6. The light-emitting device according to claim 3, wherein
the base further has a second through-hole at a position corresponding to the first through-hole, and
the drawing part is inserted into the second through-hole, and has the other end that is attached to the rear surface of the base.

7. The light-emitting device according to claim 3, wherein the drawing part has flexibility.

8. The light-emitting device according to claim 5, further comprising a switching part that switches an attaching position of the drawing part to the base.

9. The light-emitting device according to claim 1, further comprising a driver that increases and decreases tension in the anchoring member.

10. The light-emitting device according to claim 9, further comprising:
a tension detector that detects tension to be loaded on the anchoring member; and
a controller that causes the driver to adjust the tension on a basis of the tension detected by the tension detector.

11. The light-emitting device according to claim 9, further comprising:
an energy detector that detects input energy to be inputted to the light sources;
a memory that stores data indicating a relationship between the input energy and an amount of displacement of the optical sheet, the displacement being caused by heat generation involved in lighting of the light sources; and
a controller that causes the driver to adjust the tension on a basis of the input energy detected by the energy detector and the data.

12. A display apparatus comprising:
a liquid crystal panel; and
a light-emitting device on side of a back surface of the liquid crystal panel,
the light-emitting device including
a base on which one or more light sources are provided, the base including a front surface and a rear surface,
an optical sheet including an inner surface that faces the front surface of the base and an outer surface on side opposite to the base,
one or more columnar members that stand between the base and the optical sheet, the columnar members each including a top part that abuts on the inner surface of the optical sheet or is provided abuttable on the inner surface of the optical sheet, and
one or more anchoring members that each couple the base and the optical sheet, the anchoring members each exhibiting elasticity in at least a portion thereof.

13. A lighting apparatus comprising a light-emitting device,
the light-emitting device including
a base on which one or more light sources are provided, the base including a front surface and a rear surface,
an optical sheet including an inner surface that faces the front surface of the base and an outer surface on side opposite to the base,
one or more columnar members that stand between the base and the optical sheet, the columnar members each including a top part that abuts on the inner surface of the optical sheet or is provided abuttable on the inner surface of the optical sheet, and
one or more anchoring members that each couple the base and the optical sheet, the anchoring members each exhibiting elasticity in at least a portion thereof.
